(19) United States
(12) Patent Application Publication
(10) Pub. No.: US 2020/0005560 A1
(43) Pub. Date: Jan. 2, 2020

(54) Portable chassis checking module

(71) Applicant: Richard Forkes, Sleepy Hollow, IL (US)

(72) Inventor: Richard Forkes, Sleepy Hollow, IL (US)

(21) Appl. No.: 16/024,873

(22) Filed: Jul. 1, 2018

(51) Int. Cl. G07C 5/08; G05B 19/05; G06F 13/42

(52) U.S. Cl. CPC G07C 5/0808; G07C 2205/02; G06F 13/4282; G05B 19/05

(57) ABSTRACT

The invention is a portable chassis checking module. The module provides a 7-pin connector, which may be connected to a vehicle chassis to perform a basic diagnostic check. When activated, the 7-pin connector provides power to the chassis to ensure that all lights are functional, providing a Programming Logic Controller (PLC) which is programmed to continuously cycle through the chassis lights. The module further provides a Universal Service Bus (USB) port, enabling connection to media devices for programming and maintenance. The module is powered by a removable battery which may be attached to a charging hub to be recharged.

### CROSS-REFERENCE TO RELATED APPLICATIONS

This application relates back to, and claims the priority of Provisional Patent Application No. 62/530,109 filed on Jul. 8, 2017.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to automotive repair equipment and tools, and in particular to a portable chassis checking module. Vehicles are being manufactured with more and more factory installed electric and electronic components. To test components and diagnose problems, repair shops have become stocked with a variety of expensive, cumbersome electronic equipment. Unfortunately, without being towed it is impossible for an inoperable vehicle to be brought into a service bay for diagnostic work. Many owners of busy repair shops would also prefer to be able to perform some preliminary diagnostic work before the vehicle is brought into the shop, even if it runs.

A search of the prior art reveals various devices which have been developed to provide the features of a chassis checking module. In particular, none of the prior art devices provide a portable chassis checking module. None are closely related to the present invention, but several include features which resemble those of the present invention. Each has proven to be less than satisfactory for the present purpose in its own way.

Malfunction diagnosis system and method for on-vehicle electronic control units, U.S. Pat. No. 6,128,560 (priority Feb. 26, 1996), provides a diagnosis system for diagnosing malfunctions of on-vehicle electronic control units (ECU) which includes a plurality of ECUs and a diagnostic tester. The ECUs are connected to one another, thereby forming a communications network. The ECUs store a data related to malfunctions. A diagnostic tester is connected to an engine ECU for reading the data stored in the ECUs. The tester transmits an initialization signal at a low speed to the ECU when starting communicating with one of the ECUs. The ECU selects a transmission rate between the ECU and the tester based on the initialization signal.

Diagnostics, protection, and isolation system for electronic devices on a vehicle data communication bus, U.S. Pat. No. 6,831,375 (priority Sep. 6, 2000), provides a system for use in programming and diagnostics of electronic devices in a vehicle includes a connector jack having a plurality of electrical connection sites configured for electrical connection to the electronic devices in the vehicle. A shorting plug configured to removably engage the connector jack interconnects the plurality of electrical connection sites to form a data communication bus. An electronics module configured to removably engage the connector jack in place of the shorting plug includes a plurality of switching units that, when set in a closed state, electrically interconnect each of the electronic devices to form the data communication bus. Each switching unit in the electronics module is selectively and independently operable to electrically disconnect an electronic device from the data communication bus, especially for programming and diagnostics of the electronic devices in the vehicle.

Diagnostic system for electronic automotive system, U.S. Pat. No. 5,550,762 (priority Dec. 20, 1993), provides a device for quickly and accurately testing an electronic vehicle engine control module having a simulated signal generator for supplying simulated or “dummy” input signals to the module under test. These simulated signals correspond to signals normally generated by peripheral automotive components such as mass air flow sensors, throttle position sensors, oxygen sensors, and the like, in proper working order. A simulation program controls the simulated signal generator and causes the simulated signal generator to generate predetermined signals appropriate to the design of the module and specific to the simulated operating conditions under which the module is being tested. The simulation program also contains acceptable ranges of output values (that should be produced by a property operating module) corresponding to the simulated operating conditions defined by the simulation program. An output signal reader receives the various output signals produced by the module under test (based upon the simulated signals fed to it) then conditions and organizes those output signals for analysis. An output evaluator receives the output signals gathered by the output signal reader and compares them to the acceptable ranges of output valves supplied by the simulation program. A diagnostic output means associated with the output evaluator displays to the repair technician any faults in the module detected by the output evaluator.

Diagnostic tester for electronic control devices in a variety of motor vehicle types, U.S. Pat. No. 6,407,554 (priority Jul. 21, 1997), provides a diagnostic tester for electronic control devices in a variety of different motor vehicles. A universal plug connection is provided that is identical for the various types of motor vehicles. The tester can be connected through the plug connection to a diagnostic plug connection in each motor vehicle that is linked with the control devices to be diagnosed. The connection is standardized mechanically with a fixed number of plug contacts but not in terms of the signal assignments of the plug contacts and the electrical properties of the signals to be transmitted. The universal plug connection is mechanically adapted to the standardized diagnostic plug connection. In addition, an adapter unit is connected to the diagnostic device side of the universal plug connection. The adapter unit automatically creates the necessary electrical connections between the plug contacts of the universal plug connection and a CPU of the diagnostic tester in accordance with the signal assignments of the plug contacts associated with each type of motor vehicle.

Diagnostic device and test method of automobile electronic control unit (ECU), Chinese Patent No. CN102393738A (priority Dec. 16, 2011), provides a diagnostic device and a test method of an automobile electronic control unit (ECU), which belongs to the automobile electronic technology field, are disclosed. By using a current special diagnostic tool, diagnosis service parameter test of a network layer and an application layer is difficult to be independently realized. By using the device and the test of the invention, the above problem can be solved. The diagnostic device of the automobile ECU comprises: a main controller module, a CAN data communication module, a USB interface module, a K wire data communication module and a test project indication module. By using the test method of an automobile ECU, a data link layer data length test, a filling test, a network layer control parameter test, a time parameter test, an unexpected frame test and an application layer diagnosis service test can be realized. The device and the method of the invention are used for realizing the comprehensive test of the network layer and application layer diagnosis service and the service parameter independently.

A portable chassis checking module, which is battery-powered and provides a 7-pin connector to perform a basic diagnostic check on a vehicle chassis, would resolve this problem.

### SUMMARY OF THE INVENTION

Accordingly, the invention is a portable chassis checking module. The module provides a 7-pin connector, which may be connected to a vehicle chassis to perform a basic diagnostic check. When activated, the 7-pin connector provides power to the chassis to ensure that all lights are functional, providing a Programming Logic Controller (PLC) which is programmed to continuously cycle through the chassis lights. The module further provides a Universal Service Bus (USB) port, enabling connection to media devices for programming and maintenance. The module is powered by a removable battery which may be attached to a charging hub to be recharged.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a side view of the first exemplary embodiment, displaying the module 10, the 7-pin connector 11, the grip 12, the cover 13, the battery 14, the battery release button 15, and the battery lights 16.

FIG. 2 is a side perspective view of the first exemplary embodiment, displaying the module 10, the 7-pin connector 11, the grip 12, the cover 13, the battery 14, the battery release button 15, the battery lights 16, and the power button 17.

FIG. 3 is a side perspective view of the battery of the first exemplary embodiment connected to a charging hub, displaying the battery 14, the battery release button 15, the charging hub 19, and the power cord 20.

FIG. 4 is a top view of the first exemplary embodiment, displaying the module 10, the 7-pin connector 11, the grip 12, the cover 13, the battery 14, the battery lights 16, and the power button 17.

FIG. 5 is a top perspective view of the first exemplary embodiment, displaying the module 10, the 7-pin connector 11, the grip 12, the cover 13, the battery 14, the battery release button 15, the battery lights 16, and the power button 17.

FIG. 6 is a top perspective view of the first exemplary embodiment with the cover and battery removed, displaying the module 10, the 7-pin connector 11, the grip 12, the cover 13, the battery 14, the battery release button 15, the battery lights 16, the power button 17, and the PLC 18.

FIG. 7 is a side view of the first exemplary embodiment with the cover and battery removed, displaying the module 10, the 7-pin connector 11, the grip 12, the cover 13, the battery 14, the battery release button 15, the battery lights 16, and the PLC 18.

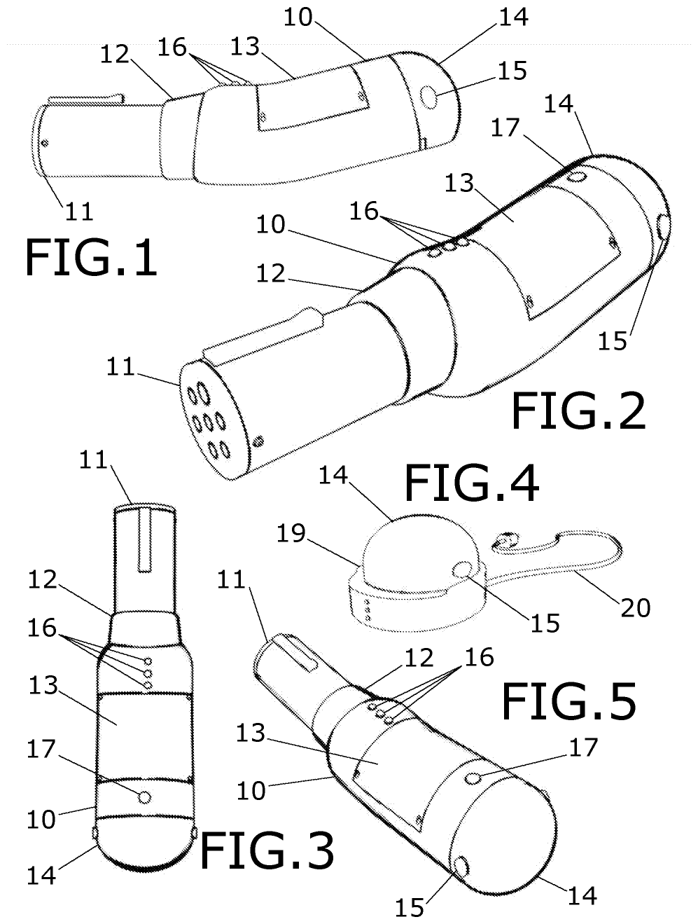

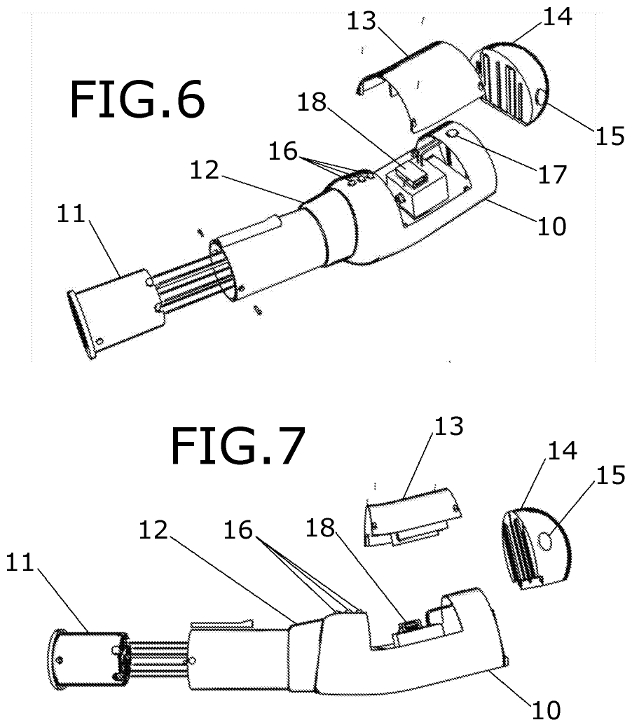

### DETAILED DESCRIPTION OF THE INVENTION

Referring now to the invention in more detail, the invention is a portable chassis checking module 10.

It is to be understood that while the invention is intended for use as a chassis checking device, this is not intended as a limitation. With suitable modification, the invention may be used for other electronic diagnostic purposes.

The first exemplary embodiment is comprised of a portable chassis checking module 10. The module 10 provides a 7-pin connector 11, which may be connected to a vehicle chassis to perform a basic diagnostic check. When activated, the 7-pin connector 11 provides power to the chassis to ensure that all lights are functional. A tapering rubber grip 12 enables the user to hold and manipulate the module 10 as desired.

A removable cover 13 is provided, which protects an internal Programming Logic Controller (PLC) 18. The PLC 18 is programmed to continuously cycle through the chassis lights. A plurality of battery lights 16 illuminate to signify that various stages in the diagnostic process have been completed. The module 10 further provides a power button 17 and a Universal Service Bus (USB) port, enabling connection of the PLC 18 to media devices for programming and maintenance, and a simple pop-out fuze between the PLC and the chassis to prevent power overload and burnout.

The module 10 is powered by a removable battery 14 which may be removed by pressing a battery release button 15. Once removed, the battery 14 may be attached to a charging hub 19 to be recharged. The charging hub 19 provides a power cord 20, which may be plugged into any standard wall outlet.

Electronic components of the PLC 18 preferably include a transmitter, a receiver, a microprocessor, a memory device, and a battery.

To use the first exemplary embodiment, the user may connect the 7-pin connector 11 to the chassis wiring harness and press the power button 17. Further operation of the module 10 is automatic.

The module 10, the 7-pin connector 11, the grip 12, the cover 13, the battery 14, the battery release button 15, the battery lights 16, the power button 17, the PLC 18, and the charging hub 19 are preferable manufactured from rigid, durable materials, such as steel, aluminum alloy, brass, and plastic. The power cord 20 is preferably manufactured from braided copper alloy wire sheathed in plastic. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A portable chassis checking module, which provides a 7-pin connector, which may be connected to a vehicle chassis to perform a basic diagnostic check, such that when activated, the 7-pin connector provides power to the chassis to ensure that all lights are functional.

2. The module of claim 1, wherein a tapering rubber grip enables the user to hold and manipulate the module as desired.

3. The module of claim 1, wherein a removable cover is provided, which protects an internal Programming Logic Controller (PLC) which is programmed to continuously cycle through the chassis lights.

4. The module of claim 1, wherein a plurality of battery lights illuminate to signify that various stages in the diagnostic process have been completed.

5. The module of claim 1, wherein the module further provides a power button and a Universal Service Bus (USB) port, enabling connection of the PLC to media devices for programming and maintenance, and a simple pop-out fuze between the PLC and the chassis to prevent power overload and burnout.

6. The module of claim 1, wherein the module is powered by a removable battery which may be removed by pressing a battery release button.

7. The module of claim 1, wherein once removed, the battery may be attached to a charging hub to be recharged.

8. The module of claim 1, wherein the charging hub provides a power cord, which may be plugged into any standard wall outlet.

9. The module of claim 1, wherein electronic components of the PLC preferably include a transmitter, a receiver, a microprocessor, a memory device, and a battery.

10. The module of claim 1, wherein the user may connect the 7-pin connector to the chassis wiring harness and press the power button; further operation of the module is automatic.

11. The module of claim 1, wherein the module, the 7-pin connector, the grip, the cover, the battery, the battery release button, the battery lights, the power button, the PLC, and the charging hub are preferable manufactured from rigid, durable materials, such as steel, aluminum alloy, brass, and plastic.

12. The module of claim 1, wherein the power cord is preferably manufactured from braided copper alloy wire sheathed in plastic.
